(19) United States
(12) Patent Application Publication
(10) Pub. No.: US 2023/0022282 A1
(43) Pub. Date: Jan. 26, 2023

(54) CLIP-ON DESK LAMP

(71) Applicant: SHENZHEN QIANHAI PATUOXUN NETWORK AND TECHNOLOGY CO., LTD., Shenzhen (CN)

(72) Inventors: Wangfa Zhan, Shenzhen (CN); Weihua Dong, Shenzhen (CN)

(21) Appl. No.: 17/461,994

(22) Filed: Aug. 30, 2021

(30) Foreign Application Priority Data
Jul. 20, 2021 (CN) 202121658503.X

(51) Int. Cl. F21S 6/00; F21V 21/088; F21V 21/14

(52) U.S. Cl. CPC F21S 6/003; F21V 21/088; F21V 21/14; F21W 2131/30

(57) ABSTRACT

The disclosure discloses a clip-on desk lamp, including a holder including a first clamping part which has a first clamping fixed end and a second clamping part which has a second clamping fixed end, wherein the first clamping part and the second clamping part are hinged by torsional spring so as to make the first clamping fixed end and the second clamping fixed end generate opposite clamping forces; a first adjusting plate arranged between the first clamping fixed end and the second clamping fixed end, and mounted to the first clamping fixed end rotatably; a lamp body mounted on a side of the second clamping part departing from the first clamping part.

### CROSS REFERENCE TO RELATED APPLICATIONS

The present application claims the benefit of Chinese Patent Application No. 202121658503.X filed on Jul. 20, 2021, the contents of which are incorporated herein ley reference in their entirety.

### FIELD

The disclosure relates to the technical field of illumination devices, in particular to a clip-on desk lamp.

### BACKGROUND

A desk lamp is an article of daily use which often needs to be used in life now. The clip-on desk lamp is generally clipped onto a plate-shaped object using two plates, which saves the space, and adjusts the height and the illumination angle freely using a universal elbow, in order to build a better illumination environment. In the process of using the existing clip-on desk lamp, since the uneven overall weight of the desk lamp, and the small contact area of the clamping plate and the supporting plate, it is easy to cause the desk lamp be clamped unsteadily and tilt to a side, which affects the using effect.

### SUMMARY

The main purpose of the present disclosure is to provide a clip-on desk lamp, aiming to solve the technical problem that how to improve the clamping stability of the clip-on desk lamp.

To implement the above purpose, the present disclosure presents a clip-on desk lamp comprising:

a holder comprising a first clamping part and a second clamping part disposed oppositely, the first clamping part has a first clamping fixed end, the second clamping part has a second clamping fixed end, the first clamping part and the second clamping part are hinged so that the first clamping fixed end and the second clamping fixed end generate opposite clamping forces;

a first adjusting plate disposed between the first clamping fixed end and the second clamping fixed end, and mounted to the first clamping fixed end rotatably;

a lamp body mounted on a side of the second clamping part departing from the first clamping part.

Optionally, the first adjusting plate is provided with a protruding lug, the first clamping fixed end is provided with a transfer slot, the lug rotatably fits with the transfer slot.

Optionally, the lug removably fits with the transfer slot.

Optionally, the lug is provided with a via hole, the first clamping fixed end is provided with a through hole, the through hole passes through the transfer slot and opposites to the via hole, the holder further comprises a connecting shaft passing through the through hole and the via hole.

Optionally, the first adjusting plate has a clamping surface facing the second clamping fixed end, the holder further comprises an anti-slip mat arranged on the clamping surface.

Optionally, the clamping surface is formed with a positioning slot, the anti-slip mat is installed to the positioning slot.

Optionally, the clamping surface is provided with a protruding positioning ring, the positioning ring is enclosed to form the positioning slot.

Optionally, the anti-slip mat is provided as a silicone mat.

Optionally, an edge of the first adjusting plate is provided with a protruding border, the border is provided around a part of a broadside of the first clamping part near the first clamping fixed end.

Optionally, the clip-on desk lamp further comprises a second adjusting plate disposed between the second clamping fixed end and the first adjusting plate, and mounted to the second clamping fixed end rotatably.

In the clip-on desk lamp of the present disclosure, a rotatable first adjusting plate is provided at the first fixed end of the first clamping part, thereby the first adjusting plate, instead of the first clamping fixed end, is clamped to the supporting plate, thereby the contact area between the first clamping part and the supporting plate can be increased, to improve the clamping stability. Since the first adjusting plate can rotate relative to the first clamping part, it can adapt to the supporting plates with different thickness or tilt angles, to improve the adaptability of the clip-on desk lamp to the clamping environment and to improve the using effect.

### BRIEF DESCRIPTION OF THE DRAWINGS

In order to describe the technical solutions in the embodiments of the present disclosure or in the prior art more clearly, the drawings that need to be used in the description of the embodiments or the prior art will be introduced briefly as follows. Obviously, the drawings in the following description are only some embodiments of the present disclosure. For one skilled in the art, other drawings may be obtained according to the structure shown in these drawings without creative work.

FIG. 1 is a structural schematic diagram of an embodiment of a clip-on desk lamp of the present disclosure;

FIG. 2 is a structural schematic diagram of an embodiment of a holder in the present disclosure;

FIG. 3 is a structural schematic diagram of an embodiment of a holder in the present disclosure;

FIG. 4 is a partial exploded schematic diagram of an embodiment of a holder in the present disclosure;

FIG. 5 is a profile exploded schematic diagram of an embodiment of a holder in the present disclosure;

FIG. 6 is a partial schematic diagram of an embodiment of a holder in the present disclosure;

FIG. 7 is a partial exploded schematic diagram of another embodiment of a holder in the present disclosure, labels and descriptions thereof:

| label | name | label | name | label | name |
|---|---|---|---|---|---|
| 10 | holder | 11 | first | 12 | second |
| 111 | first | | clamping | | clamping |
| | clamping | | part | | part |
| | fixed end | 112 | second | 13 | torsional |
| 20 | first | | clamping | | spring |
| | adjusting | | fixed end | 21 | lug |
| | plate | 30 | lamp body | 113 | through |
| 112 | transfer | 211 | via hole | | hole |
| | slot | 22 | clamping | 15 | anti-slip |
| 14 | connecting | | surface | | mat |
| | shaft | 24 | positioning | 25 | border |
| 23 | positioning | | ring | | |
| | slot | | | | |
| 40 | second | | | | |
| | adjusting | | | | |
| | plate | | | | |

The implementation of the purpose, the functional characteristics and the advantages of the present disclosure will be further described in conjunction with the embodiments and with reference to the accompany drawings.

### DETAILED DESCRIPTION

The technical solutions in the embodiments of the present disclosure will be described clearly and completely in conjunction with the drawings in the embodiments of the present disclosure as follows. Obviously, the described embodiments are only a part of the embodiments of the present disclosure, rather than all of the embodiments. Based on the embodiments in the present disclosure, all other embodiments obtained by one skilled in the art without creative work shall fall within the protective scope of the present disclosure.

It is necessary to be noted that all directional indications (such as up, down, left, right, front, back . . . ) in the embodiments of the present disclosure are only used to explain the relative position relationship, movement situation and so on between various components in a particular posture (as shown in the drawings). If the particular posture changes, the directional indication will change accordingly.

In addition, the descriptions related to “first”, “second” and so on in the present disclosure are only for descriptive purpose, and cannot be understood as indicating or implying their relative importance or implicitly indicating the number of indicated technical features. Thereby, the features defined with “first” and “second” may include at least one of the features explicitly or implicitly. In addition, “and/or” herein includes three solutions, taking A and/or B as an example, includes the A technical solution, the B technical solution, and the technical solution that meets A and B at the same time. In addition, the technical solutions of the various embodiments can be combined with each other, but it must be combined based on what can be achieved by one skilled in the art. When the combination of the technical solutions is contradictory or cannot be implemented, it should be considered that this combination of the technical solutions does not exist, nor is within the protective scope claimed in the present disclosure.

The disclosure provides a clip-on desk lamp, which is fixed to the supporting structure by clamping, such as a head of a bed, a desktop and so on, so as to illuminate the area therein.

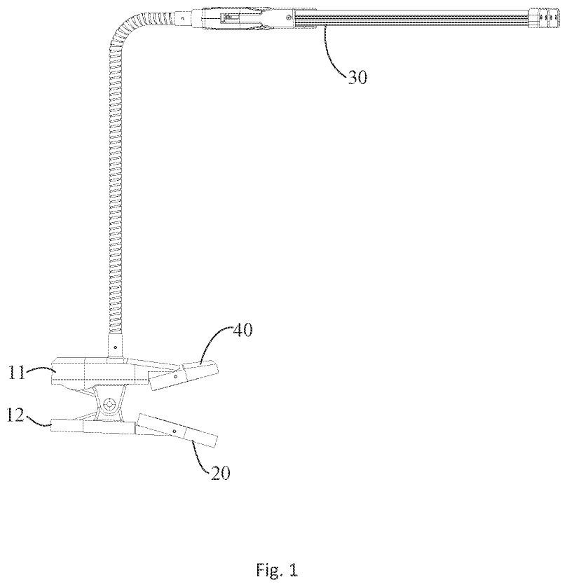

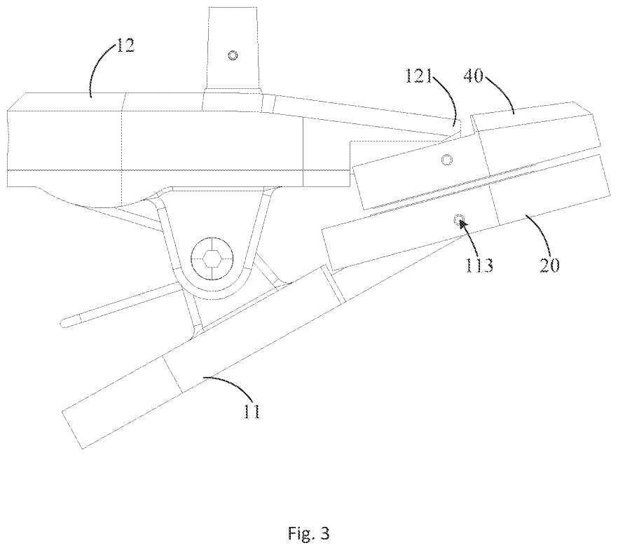

In an embodiment of the present disclosure, as shown in FIGS. 1 to 7, the clip-on desk lamp includes: a holder 10 including a first clamping part 11 and a second clamping part 12 disposed oppositely, wherein the first clamping part 11 has a first clamping fixed end 111, the second clamping part 12 has a second clamping fixed end 121, the first clamping part 11 and the second clamping part 12 are hinged by a torsional spring 13 so that the first clamping fixed end 111 and the second clamping fixed end 121 generate opposite clamping forces; a first adjusting plate 20 disposed between the first clamping fixed end 111 and the second clamping fixed end 121, and mounted to the first clamping fixed end 111 rotatably; and a lamp body 30 mounted on a side of the second clamping part 12 departing from the first clamping part 11.

In this embodiment, the first clamping part 11 and the second clamping part 12 can be disposed in a plate or a shell shape, which is not restricted here, as long as it is satisfied that the first clamping part 11 and the second clamping part 12 are hinged by the torsional spring 13. After the first clamping part 11 and the second clamping part 12 are hinged, under the effect of torsional spring 13, the first clamping fixed end 111 and the second clamping fixed end 121 apply forces to and lean against each other, to generate opposite clamping forces, so as to clamp fixed on the supporting plate. It can be understood that if the thickness of the supporting plate is less than the maximum distance between the first clamping fixed end 111 and the second clamping fixed end 121 after opening, at least one of the first clamping part 11 and the second clamping part 12 would be angled with the supporting plate after the holder 10 is clamped on the supporting plate. Taking the first clamping part 11 is angled with the supporting plate as an example, this means that only a part of the first clamping fixed end 111 positioned at an end thereof leans against the supporting plate, and the contact area is small. The smaller the thickness of the supporting plate, the smaller the contact area between the first clamping fixed end 111 and the supporting plate, and the less stable the clamping effect is.

The specific connection mode between the first adjusting plate 20 and the first clamping fixed end 111 is not restricted, as long as it is satisfied that the first adjusting plate 20 can rotate relative to the first clamping fixed end 111. The first adjusting plate 20, instead of the first clamping fixed end 111, can contact with the supporting plate, and the clamping force of the first clamping fixed end 111 can also act on the supporting plate through the first adjusting plate 20. The first adjusting plate 20 can rotate to be parallel to the clamping surface of the first clamping part 11, also can rotate to be in any acute angle with the clamping surface of the first clamping part 11. As a result, when the holder 10 clips on a supporting plate with a smaller thickness, the first adjusting plate 20 can rotate to be opposed to a supporting plate in parallel and then to lap to the supporting plate, so as to increase the lapping area with the supporting plate. The clamping force of the first clamp fixed end 111 will act on the supporting plate through the first adjusting plate 20. That is to say, the first clamping fixed end 111 would press the first adjusting plate 20 onto the supporting plate, so as not to affect the clamping force of the first clamping fixed end 111.

Thereby, the first adjusting plate 20 can not only increase the clamping area of the first clamping part of 11 with the supporting plate, but also can maintain the clamping strength of the first clamping part 11 to the supporting plate, so as to improve the clamping stability of the first clamping part of 11 relative to the supporting plate. For the supporting plates with different thicknesses, the first adjusting plate 20 can rotate to lap therewith in parallel, so as to improve the clamping effect of the holder 10 in different circumstances.

The lamp body 30 can be connected to the second clamping part 12 through a universal elbow, so that the user can adjust the illumination direction of the lamp body 30. In particular, the second clamping part 12 can include a shell and a circuit component arranged in the shell, the circuit component is electrically connected with the lamp body 30, so as to transfer electric energy for the lamp body 30, and the second clamping part 12 can play a protective role on the circuit component.

Since the lamp body 30 is installed onto the second clamping part 12, the overall weight of the second clamping part 12 is greater than that of the first clamping part 11. In the clamping state of the clip-on desk lamp, the second clamping part 12 is usually located below the supporting plate. That is to say, the center of gravity of the holder 10 is located above the supporting plate, which results in that the second clamping part 12 is easy to slide away in the direction departing from the supporting plate. And the first adjusting plate 20 installed on the first clamping part 11 makes the first adjusting plate 20 lap to the lower surface of the supporting plate, to increase the force area of the first clamping part 11 to the supporting plate, thereby limiting the slippage of the first clamping part 11, making the first clamping part 11, the second clamping part 12 and the supporting plate keep in a more stable state, to further improve the clamping effect.

In the present disclosure, the rotatable first adjusting plate 20 is provided at the first fixed end of the first clamping part 11, thereby the first adjusting plate 20, instead of the first clamping fixed end 111, is clamped on the supporting plate, so that the contact area between the first clamping part 11 and the supporting plate can be increased, to improve the clamping stability. Since the first adjusting plate 20 can rotate relative to the first clamping part 11, it can adapt to the supporting plates with different thickness or tilt angles, to improve the adaptability of the clip-on desk lamp to the clamping environment, and to improve the using effect.

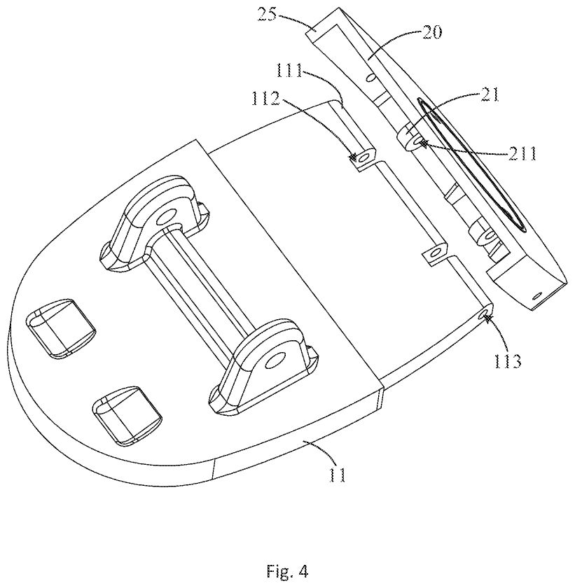

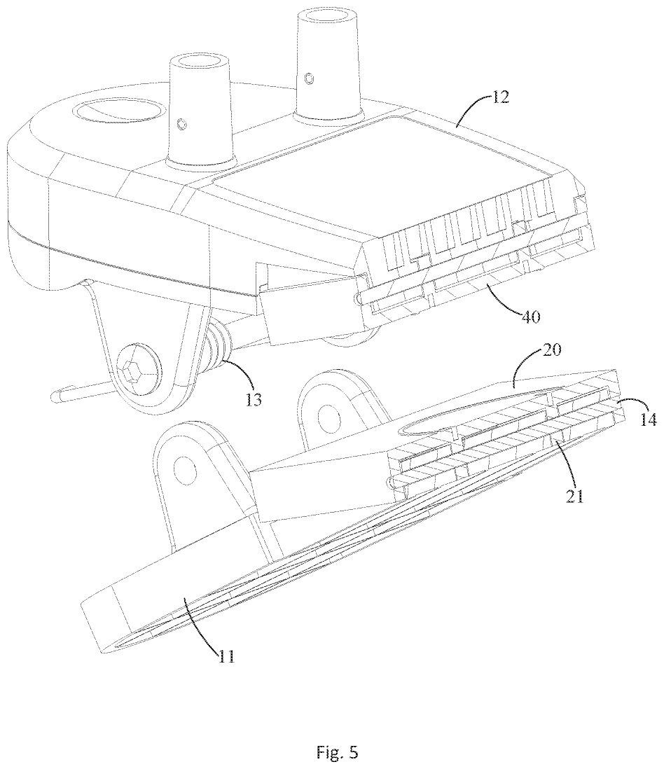

In an embodiment, as shown in FIGS. 4 and 5, the first adjusting plate 20 is provided with a protruding lug 21, the first clamping fixed end 111 is provided with a transfer slot 112, and the lug 21 rotatably fits with the transfer slot 112.

The protruding lug 21 is arranged on a side of the first adjusting plate 20 facing the first clamping fixed end 111, the particular connection mode between the lug 21 and the transfer slot 112 is not restricted, as long as the rotatable fitting is satisfied. For example, the lug 21 is provided with a protruding connecting projection, and the slot wall of the transfer slot 112 is provided with a connecting hole, and the connecting projection rotatably fits with the connecting hole to implement the rotational fitting of the lug 21 and the transfer slot 112. The number of the transfer slots 112 can be multiple and the transfer slots are arranged along the length direction of the first clamping fixed end 111 at intervals, the number and the positions of the lugs 21 correspond to those of the transfer slots 112, so as to increase the connection parts of the first adjusting plate 20 and the first clamping part 11, and to improve the installation stability of the first adjusting plate 20.

In an embodiment, the lug 21 removably fits with the transfer slot 112, to facilitate the user to replace the first adjusting plate 20, so that the Whole holder 10 is not necessary to be discarded when the first adjusting plate 20 is damaged, to improve the overall service life of the holder 10.

In particular, as shown in FIGS. 4 to 7, the lug 21 is provided with a via hole 211, the first clamping end 111 is provided with a through hole 113, the through hole 113 passes through the transfer slot 112 and opposites to the through hole 211, the holder 10 further includes a connecting shaft 14, the connecting shall 14 is disposed passing through the through hole 113 and the via hole 211. The connecting shall 14 goes through the slot wall of the transfer slot 112 and actively fits with the via hole 211, so that the first adjusting plate 20 can rotate relative to the connecting shaft 14. The connecting shaft 14 is removably disposed passing through the through hole 113, and an end of the connecting shaft 14 is exposed to the side wall of the first clamping part 11, so that the user can just pull out the connecting shaft 14 from the through hole 113 when he/she needs remove the first adjusting plate 20.

In an embodiment, the first adjusting plate 20 has the clamping surface 22 oriented toward the second clamping fixed end 121, and the holder 10 further includes an anti-slip mat 15 (not shown in the figures) disposed on the clamping surface 22. The anti-slip mat 15 is used to lean against the supporting plate, the friction coefficient of the anti-slip mat 15 is larger, which can increase the friction between the first adjusting plate 20 and the supporting plate, so as to prevent the first adjusting plate 20 from sliding relative to the supporting plate, and further to improve the clamping stability of the holder 10. The anti-slip mat 15 can be provided as a silicone mat to adapt to the uneven plate surface of the supporting plate through the flexible deformation, so as to improve the contact stability with the supporting plate. In addition, the silicone can further improve the anti-corrosion performance of the non-slip mat 15 to extend the service life of the non-slip mat 15.

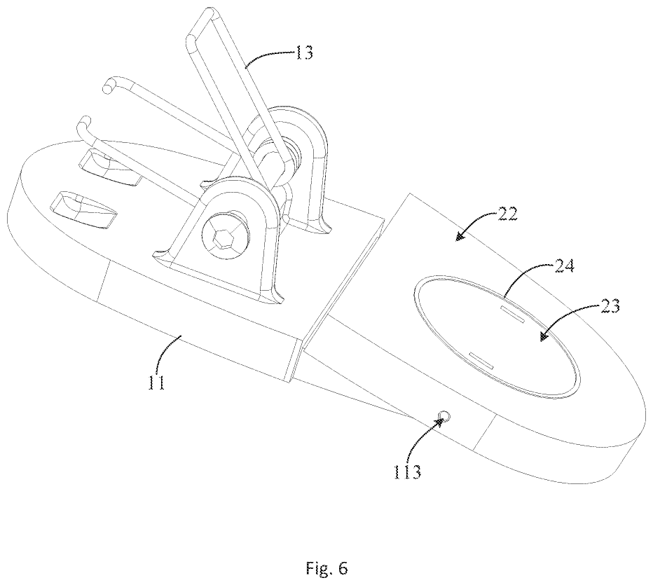

In particular, as shown in FIG. 6, the clamping surface 22 is formed with a positioning slot 23, and the anti-slip mat 15 is installed to the positioning slot 23. The positioning slot 23 can be recessed relative to the clamping surface 22, also can be formed by enclosing the protruding projection structure provided in the clamping surface 22, which is not restricted here. The positioning slot 23 can implement the positioning installation of the anti-slip mat 15 in the clamping surface 22, so as to avoid the anti-slip mat 15 falling off from the first adjusting plate 20, thereby improving the installation stability of the anti-slip mat 15. In practical application, as shown in FIG. 6, the clamping surface 22 is provided with a protruding positioning ring 24, and the positioning ring 24 is enclosed to form the positioning slot 23. The positioning ring 24 protruding from the clamping surface 22 is enclosed to form the positioning slot 23, which can avoid slotting on the first adjusting plate 20 to ensure the structural strength of the first adjusting plate 20.

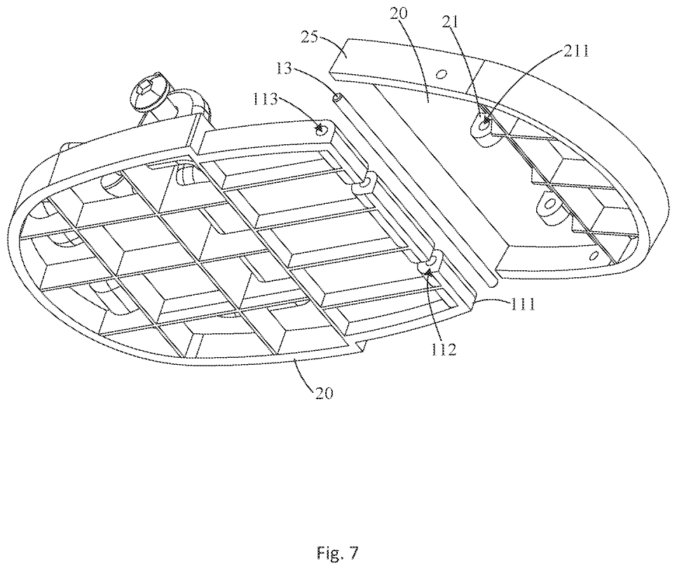

In an embodiment, as shown in FIGS. 4 and 7, a border 25 protrudes from the edge of the first adjusting plate 20, the border 25 surrounds the side of the first clamping part 11 near the first clamping fixed end 111 part. The border 25 can enhance the structural strength of the first adjusting plate 20 at the edge, and prevent the first adjusting plate 20 from breaking.

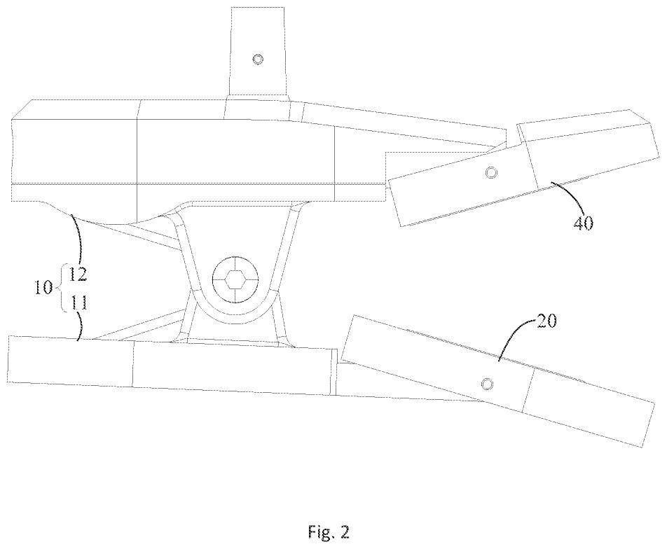

In an embodiment, as shown in FIG. 1 and FIG. 2, the clip-on desk lamp further includes a second adjusting plate 40, which is disposed between the second clamping fixed end 121 and the first adjusting plate 20 and mounted onto the second clamping fixed end 121 rotatably. The second adjusting plate 40 opposites to the first adjusting plate 20 to clamp to the two plate surfaces of the supporting plate respectively. It can be known with reference to the role of the first adjusting plate 20 that, the second adjusting plate 40 can also rotate to opposite to the plate surface of the supporting plate in parallel, so as to increase the clamping area of the first clamping part 11 and the supporting plate, to improve the clamping stability of the first clamping part 11 and the second clamping part 12 to the supporting plate simultaneously.

The above are only optional embodiments of the present disclosure, and hence does not limit the patent scope of the present disclosure. Under the concept of the present disclosure, the equivalent structure transformation made by using the content of the specification and drawings of the present disclosure, or direct/indirect applications in other related technical fields are all included in the patent protection scope of the present disclosure.

What is claimed is:

1. A clip-on desk lamp, comprising:
a holder comprising a first clamping part and a second clamping part disposed oppositely, the first clamping part has a first clamping fixed end, the second clamping part has a second clamping fixed end, the first clamping part and the second clamping part are hinged so that the first clamping fixed end and the second clamping fixed end generate opposite clamping forces;
a first adjusting plate disposed between the first clamping fixed end and the second clamping fixed end, and mounted to the first clamping fixed end rotatably; and
a lamp body mounted on a side of the second clamping part departing from the first clamping part.

2. The clip-on desk lamp described in claim 1, wherein the first adjusting plate is provided with a protruding lug, the first clamping fixed end is provided with a transfer slot, the lug rotatably fits with the transfer slot.

3. The clip-on desk lamp described in claim 2, wherein the lug removably fits with the transfer slot.

4. The clip-on desk lamp described in claim 3, wherein the lug is provided with a via hole, the first clamping fixed end is provided with a through hole, the through hole passes through the transfer slot and opposites to the via hole, the holder further comprises a connecting shaft passing through the through hole and the via hole.

5. The clip-on desk lamp described in claim 1, wherein the first adjusting plate has a clamping surface facing the second clamping fixed end, the holder further comprises an anti-slip mat arranged on the clamping surface.

6. The clip-on desk lamp described in claim 5, wherein the clamping surface is formed with a positioning slot, the anti-slip mat is installed to the positioning slot.

7. The clip-on desk lamp described in claim 6, wherein the clamping surface is provided with a protruding positioning ring, the positioning ring is enclosed to form the positioning slot.

8. The clip-on desk lamp described in claim 5, wherein the anti-slip mat is provided as a silicone mat.

9. The clip-on desk lamp described in claim 1, wherein an edge of the first adjusting plate is provided with a protruding border, the border is provided around a part of a broadside of the first clamping part near the first clamping fixed end.

10. The clip-on desk lamp described in claim 1, wherein the clip-on desk lamp further comprises a second adjusting plate disposed between the second clamping fixed end and the first adjusting plate, and mounted to the second clamping fixed end rotatably.

11. The clip-on desk lamp described in claim 2, wherein the first adjusting plate has a clamping surface facing the second clamping fixed end, the holder further comprises an anti-slip mat arranged on the clamping surface.

12. The clip-on desk lamp described in claim 11, wherein the clamping surface is formed with a positioning slot, the anti-slip mat is installed to the positioning slot.

13. The clip-on desk lamp described in claim 3, wherein the first adjusting plate has a clamping surface facing the second clamping fixed end, the holder further comprises an anti-slip mat arranged on the clamping surface.

14. The clip-on desk lamp described in claim 4, wherein the first adjusting plate has a clamping surface facing the second clamping fixed end, the holder further comprises an anti-slip mat arranged on the clamping surface.

15. The clip-on desk lamp described in claim 2, wherein an edge of the first adjusting plate is provided with a protruding border, the border is provided around a part of a broadside of the first clamping part near the first clamping fixed end.

16. The clip-on desk lamp described in claim 3, wherein an edge of the first adjusting plate is provided with a protruding border, the border is provided around a part of a broadside of the first clamping part near the first clamping fixed end.

17. The clip-on desk lamp described in claim 4, wherein an edge of the first adjusting plate is provided with a protruding border, the border is provided around a part of a broadside of the first clamping part near the first clamping fixed end.

18. The clip-on desk lamp described in claim 2, wherein the clip-on desk lamp further comprises a second adjusting plate disposed between the second clamping fixed end and the first adjusting plate, and mounted to the second clamping fixed end rotatably.

19. The clip-on desk lamp described in claim 3, wherein the clip-on desk lamp further comprises a second adjusting plate disposed between the second clamping fixed end and the first adjusting plate, and mounted to the second clamping fixed end rotatably.

20. The clip-on desk lamp described in claim 4, wherein the clip-on desk lamp further comprises a second adjusting plate disposed between the second clamping fixed end and the first adjusting plate, and mounted to the second clamping fixed end rotatably.
